(19) United States
(12) Patent Application Publication
(10) Pub. No.: US 2024/0033776 A1
(43) Pub. Date: Feb. 1, 2024

(54) APPLICATION OF PERMANENT COATINGS TO FIBER ASSEMBLIES AND FILAMENTS AND METHODS OF USE

(71) Applicant: Jennifer Thompson, Mount Gilead, NC (US)

(72) Inventor: Jennifer Thompson, Mount Gilead, NC (US)

(21) Appl. No.: 17/816,405

(22) Filed: Jul. 30, 2022

(51) Int. Cl. B05D 1/02

(52) U.S. Cl. CPC B05D 1/02; B05D 2256/00; B05D 2401/40; B05D 2501/10

(57) ABSTRACT

A complete and comprehensive device for the purposes and applications of permanent and penetrative coatings to a nearly unlimited number of synthetic and natural fiber assemblies (“superstructure assemblies”) or filaments (“shapes”) to enhance their aesthetic appearance with pigment, physical performance by changing strength or elongation, medical capability with antimicrobial material, or environmental sustainability.

### FIELD OF INVENTION

The present invention relates the purposes and applications of permanent and penetrative coatings to a broad range of carbon, glass, polymer, cellulosic, protein and other fiber assemblies and filaments to enhance their aesthetic appearance with pigment, physical performance by changing strength or elongation, medical capability with antimicrobial material, or environmental sustainability.

### BACKGROUND

Applying coatings to fiber assemblies (superstructures made from substrates ranging from cotton fibers to interlinked strands of carbon nanotubes) and filaments (polymer and monomer compounds) comprises one of the largest and most important economic activities on a global basis.

Fiber assemblies and filaments are traditionally colored using a combination of large water volumes, chemical dyes, heat, and high pressure. This process results in low penetration of color into the surface of the fiber assembly or filament, that can be later removed through use, chemical bleaches, and light of various spectra.

Chemical coatings applied to fiber assemblies and filaments to improve physical performance or medical capability are applied to the surface of the fiber assembly or filament and cured thermally or optically. However, these coatings typically erode or abrade away quickly through planned use or exposure to daylight or other light sources.

All of these methods have the disadvantage of utilizing hundreds to thousands of liters of clean water in the processing of each kilogram of material, as well as adding dozens of harmful chemicals to each of the processes to add coatings, most of which are either discarded as lightly treated or untreated waste water and other materials.

### SUMMARY OF THE INVENTION

One aspect of the invention is a process for the penetrative and durable coating of fiber assemblies and filaments with materials that create an aesthetic (color and/or texture) or performance oriented change (resistance to biological materials or enhancement of environmental requirements). These fiber assemblies and filaments are typically presented on a reel (for a single fiber assembly or filament) or warp beam (for several and as many as 2,500 fiber or more assemblies or filaments).

Another aspect of the invention is the corona discharge plasma reconfiguration of superstructures and substrates that constitute the fiber assemblies or filaments to ensure that the surface area is appropriately adhesive and that gaps are created that permit the penetrative and durable coating to become permanently affixed.

Another aspect of the invention is the exposure of the superstructures and filaments that constitute the fiber assemblies or filaments to an ionic, anionic, or acidic surfactant solutions that further enhances surface adhesions and enlarges surface gaps. Simultaneously, a thermoplastic polymer is applied with sufficient ultrasonic energy to ensure that the physical parameters are preserved for the application of the coating material.

Another aspect of the invention is the use of a linear system with elevated temperature and humidity to make sure electrical and chemical modification of the superstructures and filaments that constitute the fiber assemblies or filaments become permanent and resistant to future oxidative, heat, or other insults.

Another aspect of the invention is presentation of the superstructures and filaments that constitute the fiber assemblies or filaments to an aero-diffusion device that applies a chemical mixture of coating material at a specific pressure to the top of the substrate components of the superstructure assembly or shape. The aero-diffusion device presents of chemical mixture of coating material of a particle size to promote specific performance such as imparting pigment, bacterial resistance, temperature resistance, strength enhancement, lubrication, luminosity, reflectivity, or environmental performance (water resistance or other), along with a thermoplastic polymer to create links formed during a process or moderate heat, bringing about a cross-linking reaction, producing covalent bonds, which are insensitive to hydrolyzing agents (washing fluids, perspiration, industrial atmospheres, etc.). The superstructures and filaments that constitute the fiber assemblies or filament are rotated 180 degrees and the process is repeated on the reverse side.

Another aspect of the invention is presentation of the superstructures and filaments that constitute the fiber assemblies or filaments to final thermoplastic polymer application that acts to lock in the penetrative and durable coating prior to reloading the these fiber assemblies and filaments on to a reel (for a single fiber assembly or filament) or warp beam (for several and as many as 2,500 or more fiber assemblies of filaments).

Another aspect of this invention is that all fluids, surfactant solutions, water, pigments, and other chemicals are used in each process stage until they are exhausted. No waste is produced and no gases or fluids are released to the environment for treatment or disposal.

### BRIEF DESCRIPTION OF THE DRAWINGS

The disclosure will now be described, by way of example, with reference to the accompanying drawings in which:

FIG. 1 represents a top view of an embodiment of a device for parallelizing and closely aligning a series of superstructure assemblies or shapes and preventing tangling or crossing. FIG. 1 also represents a top view of an embodiment of the device used to make the superstructure assemblies or shapes more adhesive for later coating steps.

FIG. 2 represents a side view of an embodiment of a device to reduce the surface tension of the superstructure assemblies or shapes to make the coating steps more effective for some substrate materials.

FIG. 3 represents a side view of an embodiment of a device that fixes the treatment to the superstructure assemblies or shapes in FIG. 1 and FIG. 2.

FIG. 4 represents a bottom view of an embodiment of the device for applying coating to the top of the superstructure assemblies or shapes.

FIG. 5 represents a side view of an embodiment of the device for applying coating to the top of the superstructure assemblies or shapes.

FIG. 6 represents a side view of an embodiment of the device for applying a fixing coating to the fully coated superstructure assemblies or shapes and preparing to load the material into a container.

FIG. 7 represents an a plan view of the sum of the components used for unloading superstructure assemblies or shapes, aligning such superstructure assemblies or shapes, preparing the surface for coating, coating the top and bottom of superstructure assemblies or shapes, binding the coating, and finally loading the superstructure assemblies or shapes into a container.

FIG. 8 represents an overview of all substrates (materials from cotton fibers to carbon nanotubes) and fiber assemblies (superstructures such as cotton yarns to rayon) and filaments (polyester to carbon) that can be presented as superstructure to the invented coating system.

### DETAILED DESCRIPTION

As used herein, the following definitions shall apply unless otherwise indicated.

### I. Definitions

As used herein, “substrate” is an underlying layer of basic materials used to form a superstructure. These materials may include carbon nanotubes, filaments, or natural or synthetic fibers.

As used herein, “substrate types” refers to individual filaments or fibers of natural or synthetic origin.

As used herein, “superstructure” is a physical structure extended or developed from a basic substrate form. Examples could be multi-axial tapes woven from carbon filaments to yarns constructed from cellulosic materials such as cotton, wool, or rayon.

As used herein, “superstructure assemblies and shapes” refers to single endless filaments made from synthetic materials, multiple filament structures spun into cylindrical cords or flat tapes; Fibers of short length synthetic or natural materials spun into cylindrical yarns or formed into flat tapes

As used herein, “flat plane” refers to the horizontal presentation of one, dozens, hundreds, or thousands of superstructure assemblies on a flat horizontal plan in which the superstructure are lying side-by-side and are slightly touching one another as measured in nanometers or micrometers.

As used herein, “corona discharge plasma” explains that many materials are chemically inert, functionally nonporous, or have low surface tensions. High voltage Corona Discharge Plasma treatment has the effect modifying the surface to improve adhesion, permitting permanent coating in subsequent steps.

As used herein, “surfactant” refers to compounds that lower the surface tension between two liquids, between a gas and a liquid, or between a liquid and a solid. Surfactants are cationic, anionic, or acidic depending upon the superstructure presented for coating.

As used herein, “thermoplastic polymer” refers to a coating in which a binder, thermoplastic polymers are formed by additional polymerization and are soft and less brittle, as well as being soluble in organic solvents, are used to coat superstructure assemblies or shapes. Thermoplastic polymers can be recycled. Thermoplastic polymers can also reduce friction and act as a lubricant.

As used herein, “adhesion” refers to the tendency of dissimilar surfaces to cling to one another through dispersive adhesion in which attractive forces between two materials to intermolecular interactions between molecules of each material.

As used herein, “gaps” are rifts or fissures on the surface of a superstructure or assembly. All surfaces feature gaps that may be measured in nanometers or micrometers, and if treated electrically, chemically, or electrochemically, can be populated with materials that make up a substantial coating that can penetrate as little as 20% of the superstructure to as much as 90% of the superstructure.

As used herein, “aero-diffusion” is a technique for applying a continuity of heterogeneous material or permanent coating to a superstructure assemblies or shapes under the conditions of steady temperature-humidity. The continuity of the wetness technique is justified on the principle of equality of chemical potential.

As used herein, “fixing” is a chemical process that produces the toughening or hardening of polymer materials by cross-linking of polymer chains by exposure to temperature gradients.

As used herein, “penetration” refers to the extent to which coating materials penetrate the surface of a superstructure. In some cases described as a “donut” or ring of permanent coating material that penetrates the surface of the a superstructure. In some cases the makeup of the superstructure may limit penetration, in other cases, it may be by design that penetration is either minimized from about 20% to about 90%.

### II. Devices and Systems

Preparation Modules And Other Embodiments

One aspect of the invention is the plurality of superstructure assemblies or shapes 10 moving in direction 11 with a preset tension and speed that are first separated 13 and closely aligned before exposure to a high voltage plasma corona discharge device 14 before exit at 12.

In one embodiment of the invention, superstructure assemblies or shapes 10 come off one at time from individual reels or packages before 13.

In another embodiment of the invention, superstructure assemblies or shapes 10 come off warp beams in quantities of as much as 2,500 or more before 13.

In some embodiments of the invention the speed and tension of 10 may be increased or decreased.

In some embodiments the plurality of superstructure assemblies or shapes 10 can number from 1 to 2,500 or more.

In a further embodiment of the invention the plurality of superstructure assemblies or shapes 10 move in direction 11 with a preset tension or speed enter 30 where they are controlled by the rollers in 21 prior to submersion into a surfactant solution bath 22 charged with certain levels of ultrasonic energy, whereby they exit at 12.

In one embodiment of the invention the solution batch 22 may be cationic.

In another embodiment of the invention the solution bath 22 may be anionic.

In some embodiments of the invention the solution bath 22 may be acidic.

In some embodiments of the invention all of the unused solution bath 22 is collected and reused until the supply is exhausted.

In a further embodiment of the invention the plurality of superstructure assemblies or shapes 10 move in direction 11 enter 23 which consists of a plurality of sinusoidally arranged rollers 24 that permit the applied wetting agent 23 to penetrate and dry.

In one embodiment there may be more rollers.

In another embodiment there may be fewer rollers.

### Diffusion Module and Other Embodiments

In a further embodiment of the invention is the plurality of superstructure assemblies or shapes 10 moving in direction 11 with a preset tension and speed enter 40 where an aero-diffusion device 31 with nozzles 32 which present coating materials at a predetermined pressure to the plurality of superstructure assemblies or shapes.

In one embodiment of the invention the superstructure assemblies or shapes are inverted by 180 degrees and the reverse side of 10 are present to additional diffusion device 31.

In another embodiment of the invention the superstructure assemblies or shapes 10 moving in direction 11 with a present tension and speed enter 30 where an aero-diffusion device 31 with nozzles 32 which present a technically mixed solution of coating materials and thermoplastic binder 42 of a particle size and chemical cross-linking ability to promote specific performance such as imparting pigment, bacterial resistance, temperature resistance, strength enhancement, lubrication, luminosity, reflectivity, or environmental performance (water resistance or other).

In some embodiments of the invention all of the unused coating material 42 is collected and reused until the supply is exhausted.

### Fixing Module and Other Embodiments

In another embodiment of the invention the superstructure assemblies or shapes 10 moving in direction 11 with a present tension and speed enter 50 where a fixing coating 53 and 55 is applied by 52 and 54 before exiting 11.

In some embodiments the amount of exposure may be increased by applying more fixing coating, increasing 53 and 55.

In additional embodiments the amount of exposure may be decreased by removing 55 to reduce fixing coating.

In some embodiments of the invention all of the unused fixing coating 52 and 54 is collected and reused until the supply is exhausted.

Integrated System

In another embodiment of the invention the superstructure assemblies or shapes 10 moving in direction 11 and exiting at 12 is intended to go through a specific processing sequence with a first step of high voltage corona plasma discharge 14, surfactant solution bath 22 with ultrasonic aspects, penetration in 23, application of coating materials in 42, and application of a fixing coating in 50.

### III. Methods

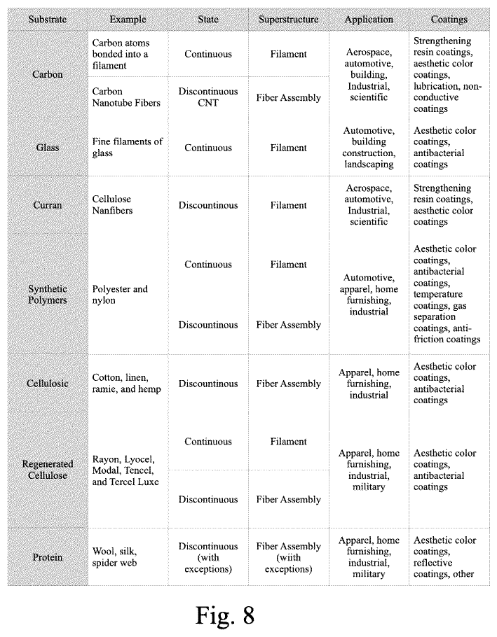

Another aspect of the invention is mechanically preparing the superstructure assemblies or shapes for electrochemical treatment. A specialized mechanical comb is used to ensure that a plurality of superstructure assemblies, for example FIG. 8, a cotton or rayon yarn, are presented on a flat plan and within nanometers of one another, but untangled.

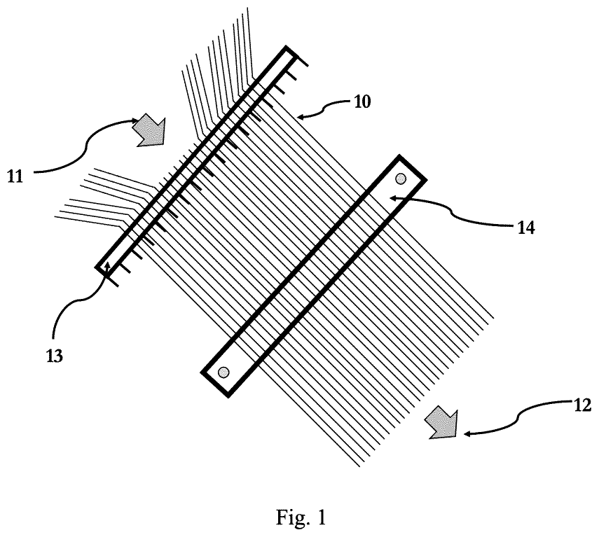

In some embodiments this plurality of untangled but very closely aligned superstructure assemblies or shapes will be in contact with and pass over a flat AC electrode that spans the plurality of superstructure assembly or shapes and permits a high voltage corona plasma discharge effect to change the electrochemical properties of the superstructure assemblies or shapes so that they become more electrically adhesive when exposed to other chemical materials later in the process. This process is demonstrated in FIG. 1.

In one embodiment only one superstructure assembly or shape will be will be in contact with and pass over a flat AC electrode that spans the plurality of superstructure assembly or shapes and permits a high voltage corona plasma discharge effect to change the electrochemical properties of the superstructure assemblies or shape so that they become more electrically adhesive when exposed to other chemical materials later in the process. This process is demonstrated in FIG. 1.

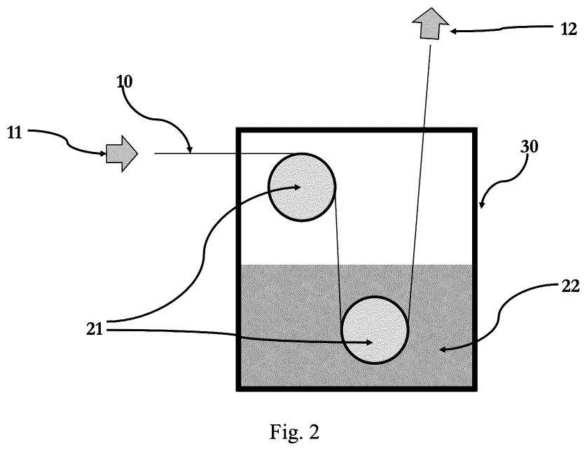

In other embodiments the presentation of the superstructure assembly or shape will be in contact with and pass over a flat AC electrode as demonstrated in FIG. 1, but bypass other steps in the process FIG. 2, because further surface treatment is unneeded for some materials FIG. 8.

Another aspect of the invention is use of a surfactant solution bath FIG. 2 that also imparts ultrasonic energy to preserve the electrical adhesiveness of the superstructure assemblies or shapes while activating gaps in the microscopic surface as measured in nanometers or micrometers. This done by submerging 10 in 22 which creates a further electrochemical effect.

In some embodiments the superstructure assemblies or shapes 10 (comprising materials FIG. 8) may require a solution bath 22 of cationic materials and certain levels of ultrasonic energy to achieve the desired electrochemical effect.

In some embodiments the superstructure assemblies or shapes 10 (comprising materials FIG. 8) may require a solution bath 22 of anionic materials and certain levels of ultrasonic energy to achieve the desired electrochemical effect.

In some embodiments the superstructure assemblies or shapes 10 (comprising materials FIG. 8) may require a solution bath 22 of acidic materials and certain levels of ultrasonic energy to achieve the desired electrochemical effect.

In some embodiments all of the materials used in the solution bath are collected, reused, and exhausted so that no waste is produced.

In other embodiments the presentation of the superstructure assembly or shape will bypass other steps in the process FIG. 2, because further surface treatment is unneeded for some materials FIG. 8.

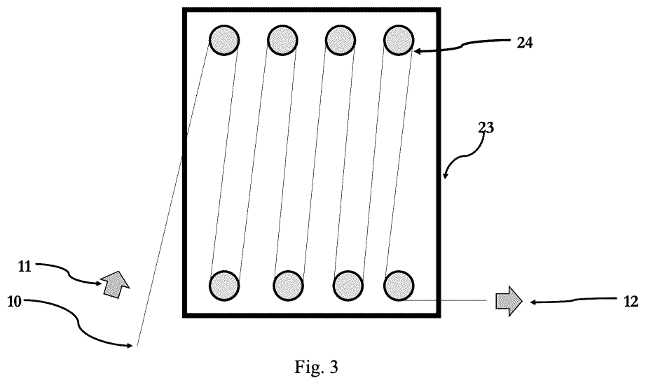

Another aspect of the invention is to exposure the treated superstructure assemblies or shapes FIG. 3 to penetrate and dry over a specific distance and time.

In some embodiments the level of heat and humidity may vary according to the superstructure assemblies or shapes 10 and material characteristic FIG. 8.

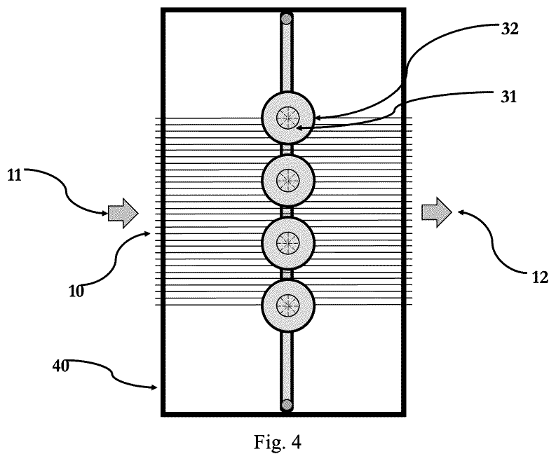

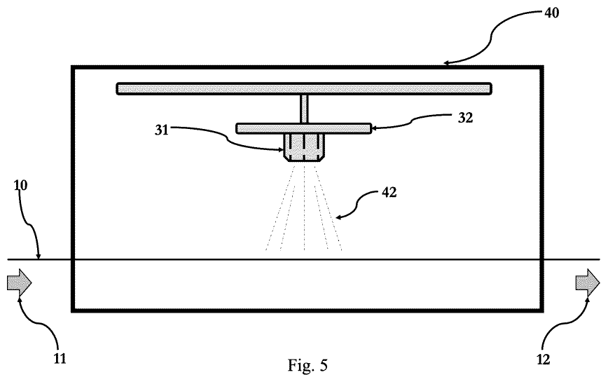

Another aspect of the invention FIG. 4 and FIG. 5 is to use aero-diffusion device 31, 32, and 42 to apply a coating material to the surface of the superstructure assembly or shapes at a present exposure and pressure FIG. 4 and FIG. 5.

In other embodiments the mixed solution of coating materials and thermoplastic binder 42 of a particle size and chemical cross-linking ability to promote specific performance, materials 42 are of a particle size to promote specific aspects such as imparting pigment, bacterial resistance, temperature resistance, strength enhancement, lubrication, luminosity, reflectivity, or environmental performance (water resistance or other).

In some embodiments the aero-diffusion device can be mechanically controlled by an operator with an electric or similar motor.

In some embodiments the aero-diffusion device 31, 32, and 42 can be digitally controlled through electrical motors and other closed-loop means.

In other embodiments the four fixed aero-diffusion units may be replaced with three fixed aero diffusion units with a larger spray pattern.

In some embodiments the aero-diffusion unit may be a single unit mounted on a carriage transport that moves over the top of the surface of the superstructure assembly or shapes.

In some embodiments all of the coating materials used by the aero-diffusion device bath are collected, reused, and exhausted so that no waste is produced.

In some embodiments of the superstructure assemblies or shapes are inverted by 180 degrees and the reverse side of 10 are present to additional diffusion device 31 to complete coat the superstructure assemblies or shapes FIG. 8.

In some embodiments the superstructure assemblies or shapes are dried and conditioned with heat, steam, both heat and steam, or other methods.

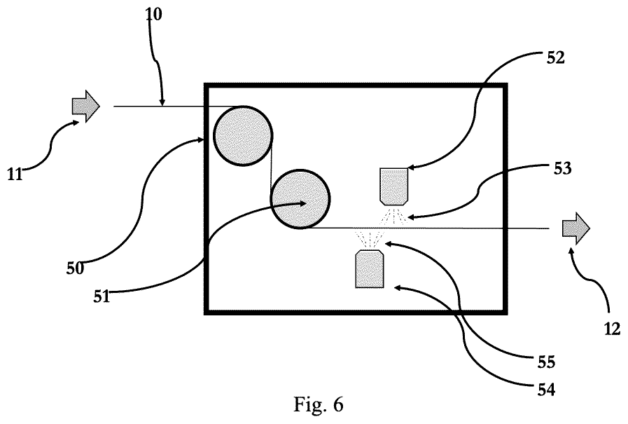

Another aspect of the invention FIG. 6 is the application of a binder material (Thermoplastic Polymer) as a final fixing coating that ensures that the coating material is protected from oxidation, abrasion, and other insults, while adding lubrication functions.

In some embodiments the amount of fixing coating may be increased 53 and 55.

In additional embodiments the amount of fixing coating may be decreased by removing 55.

In some embodiments of the invention all of the unused binder 52 and 54 is collected and reused until the supply is exhausted.

In another embodiment of the invention complete system the superstructure assemblies or shapes 10 moving in direction 11 and exiting at 12 is intended to go through a specific processing sequence with a first step of corona plasma discharge 14, solution bath 22, penetration in 23, application of coating materials in 42, and application of a binder in 50.

In some embodiments of the invention a single superstructure assembly or shape will be processed through the system at a specific speed and tension for a specific length of material FIG. 8.

In some embodiments of the invention a plurality of superstructure assemblies or shapes will be processed through the system at a specific speed and tension for a specific length of material FIG. 8.

### IV. Examples

In order that the invention described herein may be more fully understood, the following examples are set forth. It should be understood that these examples are illustrative purposes only and are not to be construed as limiting the invention in any manner.

### Example No. 1: Process Protocol

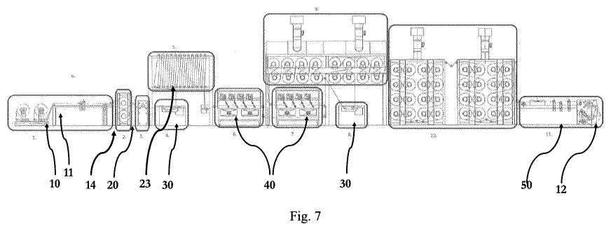

With reference to FIG. 7, an example protocol is described. Superstructure assemblies and shapes coated with this continuous process technology where a pigment or other coating is transferred from a unique aero-diffusion system without the use of traditional processing equipment, chemicals, high volumes of water, or large amounts of energy. Superstructure assemblies and shapes are delivered, ready for fabrication to any number of end uses from apparel to automotive to aerospace applications.

A range of single superstructure assembly or shape from 600 meters to 20,000 meters or more in length, see FIG. 8, is taken from a reel, or a plurality of superstructure assembly and shapes up to 2,500 or more at a time and taken from a warp beam, is lead into an adjustable comb 13 that is designed to ensure that the superstructure assembly or shapes are closely aligned and not tangled or crossed with a spacing of 1 nanometer to 10 micrometers.

The superstructure assemblies or shapes are moved over an AC electrode 14 from 3 to 100 meters per minute per FIG. 1 that are designed to utilize high voltage Corona Plasma Discharge from 0 Kw to 6 Kw to make the superstructure assemblies or shapes more adhesive or sticky.

The superstructure or assemblies are then feed into a surfactant bath of 100 liters to 1,000 liters that consists of anionic, cationic, or acidic surfactants mediated by ultrasonic energy from 0 Kw to 3 Kw per FIG. 2. This electrochemical process is designed to enhance and expand surface gaps in the superstructure assemblies or shapes that are better able to hold coating materials in further processes FIGS. 4 and 5. 360 degrees of the superstructure assemblies or shapes are treated.

After treatment in FIG. 2, the superstructure assemblies or shapes are moved through a series of sinusoidal rollers with a total length of more than 75 meters per FIG. 3, permitting penetration.

The top of the superstructure assemblies or shapes enter the enclosure in FIGS. 4 and 5. The coating material in the size of 1 nanometer to 5 nanometers 42 is applied to the surface of the superstructure assemblies or shapes under a specific pressure of about 0.5 Megapascal to about 1.5 Megapascal and speed of 3 meters per minute to 100 meters per minute. The superstructure assemblies or shapes are then inverted by 180 degrees after the coating process to expose the bottom or untreated side.

The bottom of the superstructure assemblies or shapes enter a duplicate enclosure in FIGS. 4, 5, and 7. The mix of coating material and thermoplastic binder 42 is applied to the surface of the superstructure assemblies or shapes FIG. 8 under a specific pressure and speed. This ensures that the entire surface of the materials are coated with the appropriate material designed to imparting pigment, bacterial resistance, temperature resistance, strength enhancement, luminosity, reflectivity, or environmental performance (water resistance or other). The superstructure assemblies or shapes are then exposed to a curing process to ensure the coating is fully complete.

A final processing stage applies a fixing coating to the superstructure assemblies or shapes 52, 53, 54, and 55. The fixing coating seals the coating applied per FIGS. 4 and 5, providing protection from oxidation, abrasion, and other potential insults to the superstructure assemblies or shapes.

A range of single superstructure assembly or shape up to 20,000 meters or more in length, see FIG. 8, is taken from the process and placed on a reel, or a plurality of superstructure assembly and shapes up to 2,500 or more at a time are placed on a warp beam.

### Example No. 2: Carbon Tape Embodiment

With the advent of super-tall buildings such Burj Khalifa in Dubai (828 meters/2,716 feet in height) or Shanghai Tower in Shanghai (632 meters/2,703 feet in height), traditional steel hoist cables (elevator hoist cables or “ropes” are highly engineered and made of steel with other composites. They are not single wires but several strands of various sizes wrapped together. A typical cable or rope can have over 150 strands of wire precisely designed to be strong, flexible, and provide long service. Multiple wire strands are used to increase the life of the cable and give it flexibility) cannot be used for high speed elevators or lifts used for moving passengers and freight. Traditional steel cables have a length limitation of about 500 meters (1,640 feet); At that length the hoist rope weight and sheave (pulley) shaft load on the hoist motor becomes untenable. The solution to the plus-500 meter problem has been to use flat carbon tapes in place of steel hoist ropes in the Middle East, EU, and USA. In Asia there have been instances of round carbon fiber superstructures being used. Flat carbon tapes can serve up to a kilometer in length, weigh 90% less, reduce energy consumption, reduce noise or “humming” in the hoist way, and they have a much longer life. However, unlike steel hoist ropes, wear and damage are harder to diagnose, and all four sides of the tape have to be examined. Typical flat carbon tapes used for hoist applications are 250 millimeters (˜10 inches) wide by 50 millimeters (˜2 inches) thick and up to 2,500 meters (8,200 feet) long. The material is typically treated with a protective polyurethane coating to provide a level of lubrication and protection for the flat carbon tapes.

Safety is a key certification requirement for elevators and lifts, and steel hoist ropes have an inspection protocol that has been in place since the mid-1870's. A nascent protocol for flat carbon tapes has been developed, but requires further refinement. The invention provides the ability to replace the standard polyurethane coating step associated with flat carbon tapes with a colored protective coating. The colored protective coating is designed to accomplish three objectives: First, to differentiate flat carbon tape lengths by color. Second, to use the abrasion characteristics of the colored protective coating as an inspection tool. As the color wears, inspection becomes much easier (less visible color means more wear or damage) and can be accomplished through computer vision. Third, to provide needed lubrication with hoist sheaves (pulleys).

For the invention, a manufactured and fully thermoset single flat carbon tape of 250 millimeters (˜10 inches) in width, 50 millimeters (˜2 inches) in thickness, and 1,000 meters in length (3,280 feet), are presented on a specialized reel for protective color coating and then reloaded on a specialized reel.

With reference to FIG. 7, an example protocol is described. Superstructure assemblies and shapes coated with this continuous process technology where a colored protective coating is transferred from a unique aero-diffusion system without the use of traditional processing equipment, hazardous chemicals, or large amounts of energy.

A length of single flat carbon tape from about 1,000 meters (3,280 feet) in length, see FIG. 8, is taken from a specialized reel (bypassing adjustable comb in FIG. 2) 10.

The flat carbon tape is moved over an AC electrode 14 from 3 to 100 meters per minute per FIG. 1 that are designed to utilize Corona Plasma Discharge from 0 Kw to 6 Kw to make the flat carbon tape more electrochemically adhesive or sticky.

The flat carbon tape bypasses the wetting bath FIG. 2.

The top flat carbon tape enters the enclosure in FIGS. 4 and 5. The colored coating material in the size of 1 nanometer to 5 nanometers FIG. 42 is applied to the flat carbon tape under a specific pressure of about 0.5 Megapascal to about 1.5 Megapascal and speed of 3 meters per minute to 100 meters per minute. The flat carbon tape is then inverted by 180 degrees after the coating process to expose the bottom or untreated side.

The bottom of the superstructure assemblies or shapes enter a duplicate enclosure in FIGS. 4, 5, and 7. The coating material and thermoplastic polymer binder FIG. 42 is applied to the surface of the flat carbon tape FIG. 8 under a specific pressure and speed. This ensures that the entire surface of the flat carbon tape is coated with the appropriate material designed to imparting color and wear or abrade at a respecified rate. The flat carbon tape is then exposed to a curing process to ensure the coating is fully complete.

A final processing stage applies a binder coating to the flat carbon tape 52, 53, 54, and 55. The binder seals the coating applied per FIGS. 4 and 5, providing additional protection and designed.

The flat carbon tape, up to 1,000 meters (3,280 feet) in length, see FIG. 8, is taken from the process and placed on a specialized reel.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. The device in claim 1 presents about 1 superstructure assembly or shape to about 2,500 or more individual but closely aligned superstructure or assemblies or shapes.

2. The device in claim 1 places each superstructure assembly or shape spaced about 1 nanometers to about 10 micrometers apart, on a flat plane, at any one time, with the surface slightly touching, to ensure alignment and prevent entanglement.

3. The device in claim 1 presents about 1 superstructure assembly or shape to about 2,500 or more individual but closely aligned superstructure or assemblies or shapes that are each about 600 meters to 20,000 or more meters in length.

4. The device in claim 1 uses an adjustable comb or reed assembly to ensure that the 1 superstructure assembly or shape to about 2,500 or more individual remain closely aligned and spaced from about 1 nanometers to about 10 micrometers.

5. The method in claim 2 presents the superstructure assembly or shapes are uniformly presented to an enclosure with a flat, horizontal, AC electrode that uses a high voltage corona discharge plasma from about 0 Kw to about 6 Kw to impart changes in the properties of the whole surface of the superstructure assembly or shape that make it more electrochemically receptive or adhesive for subsequent addition of coating material.

6. The device in claim 3 where a superstructure assembly or shape is introduced to an additional and separate enclosed space with multiple vertically arranged rollers adequately spaced in a sinusoidal array, some of which are submerged in a fluid bath.

7. The method in claim 3 where a superstructure assembly or shape, moving from about 3 meters per minute to about 100 meters per minute, is submerged in the fluid bath of surfactant wetting agents of about 100 liters to 1,000 liters that function to create a charged surface that reduces surface tension on the superstructure assembly or shape, opening gaps in all defined surfaces, enhancing chemical receptivity for subsequent addition of coating material.

8. The method in claim 3 where the bath of surfactant wetting agents may be cationic, depending upon the substrate upon which the superstructure assembly or shape is based, to ensure that relaxation of surface tension is optimized by substrate type.

9. The method in claim 3 where the bath of surfactant wetting agents may be anionic, depending upon the substrate upon which the superstructure assembly or shape is based, to ensure that relaxation of surface tension is optimized by substrate type.

10. The method in claim 3 where the bath of surfactant wetting agents may be acidic, depending upon the substrate upon which the superstructure assembly or shape is based, to ensure that relaxation of surface tension is optimized by substrate type.

11. The method in claim 3 enhances the surfactant wetting agent with an additional thermoplastic polymer to ensure proper surfactant binding with a particle size about 1 nanometer to about 5 nanometers.

12. The device in claim 3 mechanically mixes the surfactant wetting agent and thermoplastic polymer for optimized consistency for not less than 5 minutes and not more than 10 minutes at initial start-up and continues throughout the process at no less than 25 rpm to 35 rpm.

13. The device in claim 3 where an ultrasonic power is applied from about 0 Kw to about 3 Kw is used to optimize the penetration of surfactant wetting agent and thermoplastic polymer into the whole superstructure assembly or shape.

14. The device in claim 3 may be bypassed to create a less penetrating protective coating for carbon, glass, and polyester superstructure assembly or shapes.

15. The method in claim 3 may be modified to create a less penetrating protective coating, above 15% of the total volume but less than 90% of the total volume, for carbon, glass, and polyester superstructure assembly or shapes by moving the superstructure above 35 meters per minute.

16. The method in claim 3 may be modified to create a less penetrating protective coating above 15% of the total volume, but less than 90% of the total volume, for carbon, glass, and polyester superstructure assembly or shapes by altering the strength of cationic, anionic, and acidic surfactant wetting agents.

17. The method in claim 3 may be modified to create a less penetrating protective coating above 15% of the total volume, but less than 90% of the total volume, for carbon, glass, and polyester superstructure assembly or shapes by adding more or less thermoplastic polymer to ensure surfactant binding with particle size of about 1 nanometer to 5 nanometers.

18. The method in claim 3 may be modified to create a less penetrating protective coating of about 15% of the total volume, but less than 90% of the total volume, for carbon, glass, and polyester superstructure assembly or shapes. by optimizing ultrasonic power applied to the superstructure assembly and shape from about 0 KW to about 3 KW.

19. The method in claim 3 collects all surfactant wetting agents, thermoplastic polymer, and other materials and recirculates them without treatment or modification for reuse in creating a protective coating. This results in a zero discharge and closed-loop effect that eliminates all liquid, solid, and chemical waste.

20. The device in claim 4 includes an additional and separate enclosed space with multiple vertically arranged rollers adequately spaced in a sinusoidal array to permit lengths of the superstructure assembly or shape and the substrate that makes up that superstructure assembly or shape to adequately and precisely absorb the wetting agent as it travels through the enclosure from about 3 meters per minute to about 100 meters per minute over a linear distance of about 40 meters to about 75 meters.

21. The device in claim 5 contains an additional and enclosed space in which the top of the superstructure assembly or shape is presented at a 90 degree angle and a speed of about 3 meters per minute to 100 meters per minute to an aero-diffusion device.

22. The method in claim 5 in which the aero-diffusion device presents a chemical mixture consisting of a mix of coating material and thermoplastic polymer at a pressure of about 0.5 Megapascal to about 1.5 Megapascal that bonds to the top of the substrate components of the superstructure assembly or shape.

23. The method in claim 5 in which the aero-diffusion device presents of chemical mixture of coating material and thermoplastic polymer of a particle size to promote specific performance such as imparting pigment, bacterial resistance, temperature resistance, strength enhancement, luminosity, reflectivity, or environmental performance (water resistance or other).

24. The device in claim 5 aero-diffusion device offers a spray angle of between 45 degrees to 110 degrees from 1 centimeter to 10 centimeters from the surface of the superstructure assembly or shape.

25. The device of claim 5 rotates the superstructure assembly or shape, consisting of 1 superstructure assembly to about 2,500 or more individual shapes. by 180 degrees.

26. The device of claim 5 is an additional and enclosed space in which the reverse side of the superstructure assembly or shape is presented at a 90 degree angle at a speed of about 3 meters per minute to about 100 meters per minute to an aero-diffusion device.

27. The method in claim 5 in which the aero-diffusion device presents a chemical mixture consisting of coating material at a pressure of about 0.5 Megapascal to about 1.5 Megapascal that bonds to the top of the substrate components of the superstructure assembly or shape.

28. The method in claim 5 in which the aero-diffusion device presents of chemical mixture of coating material of a particle size to promote specific performance such as imparting pigment, bacterial resistance, temperature resistance, strength enhancement, luminosity, reflectivity, or environmental performance (water resistance or other).

29. The method of chemical mixture in claim 5 consists of certain mechanical properties and has a particle size of about 1 nanometer to about 5 nanometers.

30. The method of chemical mixture in claim 5 also contains an additional thermoplastic polyester of a particle size of about 1 nanometer to about 5 nanometer to ensure that the active chemical is permanently bound to the substrate and superstructure assembly or shape.

31. The method of chemical mixture in claim 5 is mechanically applied to the superstructure assembly or shape, at a speed of about 3 meters per minute to about 100 meters per minute, with adjustments to aero-diffusion pressure in megapascal, particle size in nanometers, and thermoplastic polymer, in a repeatable pattern to create a solid and uniform protective coating for performance applications.

32. The method of chemical mixture in claim 5 is mechanically applied to the superstructure assembly or shape, at a speed of about 3 meters per minute to about 100 meters per minute, with adjustments to aero-diffusion pressure in megapascal, particle size in nanometers, and thermoplastic polymer, in a repeatable pattern to create a irregular and non-uniform protective coating for aesthetic applications.

33. The method of chemical mixture in claim 5 is mechanically applied in such a way to ensure that aero-diffusion pressure in megapascal, particle size in nanometers, and thermoplastic polymer penetrates the surface of the superstructure or assembly from about 20% of the total volume to about 90% of the total volume.

34. The device in claim 5 mechanically mixes prior to aero-diffusion the coating materials and thermoplastic polymer for optimized consistency for not less than 5 minutes and not more than 10 minutes at initial start-up and continues throughout the process at no less than 25 rpm to 35 rpm.

35. The method of claim 5 prior to aero-diffusion presents a chemical mixture of coating material of a particle size to promote specific performance such as imparting pigment, bacterial resistance, temperature resistance, strength enhancement, lubrication, luminosity, reflectivity, or environmental performance (water resistance or other), along with a thermoplastic polymer to create links formed during a process or moderate heat, bringing about a cross-linking reaction, producing covalent bonds, which are insensitive to hydrolyzing agents (washing fluids, perspiration, industrial atmospheres, etc.).

36. The device in claim 5 that applies the chemical mixture may be manually operated with a multiplicity of application heads and nozzles to ensure adequate aero-diffusion for about 1 to about 2,500 or more individual but closely aligned superstructure or assemblies or shapes at any one time.

37. The device in claim 5 may also be operated digitally through the use of a multiplicity of automated application heads, nozzles, and software to control timing to ensure adequate aero-diffusion for about 1 to about 2,500 or more individual but closely aligned superstructure or assemblies or shapes at any one time.

38. The method in claim 5 collects all coating materials, thermoplastic polymer, and other materials and recirculates them without treatment or modification for reuse in creating a protective coating. This results in a zero discharge and closed-loop effect that eliminates all liquid, solid, and chemical waste.

39. The device in claim 6 includes an additional and separate enclosed space with multiple vertically and horizontally arranged rollers adequately spaced in a sinusoidal array to permit lengths of the superstructure assembly or shape and the substrate that makes up that superstructure assembly or shape to adequately and precisely absorb coating materials and thermoplastic polymer as it travels through the enclosure from about 3 meters per minute to about 100 meters per minute over a linear distance of about 40 meters to about 75 meters.

40. The device in claim 7 presents the superstructure assembly or shape to an additional and enclosed space at a speed from about 3 meters per minute to 100 meters per minute, exposing it to a solution tank of thermoplastic polymer of 100 liters to 1,000 liters.

41. The method in claim 7 presents the superstructure assembly or shape to an additional and enclosed space at a speed from about 3 meters per minute to 100 meters per minute, exposing it to a solution tank of 100 to 1,000 liters that is ultrasonic energized from about 0 Kw to about 3 Kw, as a final binding process.

42. The method in claim 7 results in a final surface coating that penetrates the whole superstructure assembly or shape surface to about 20% to about 90% of the total volume.

43. The method in claim 7 collects all surfactant thermoplastic polymer, and other materials, and recirculates them without treatment or modification for reuse in creating a final protective coating. This results in a zero discharge and closed-loop effect that eliminates all liquid, solid, and chemical waste.

44. The device in claim 8 presents the superstructure assembly or shape enters an additional and enclosed space, a device in claim 6, at a speed from about 3 meters per minute to 100 meters per minute.

45. The method in claim 8 presents the superstructure assembly or shape to a steam atmosphere with a temperature ranging from about 130 C to about 150 C to enable the chemistry applied to completely cure on the superstructure assembly or shape and remove extensive moisture.

46. The device in claim 9 adds a 1 micrometer to 5 micrometer protective wax coating to about 1 superstructure assembly or shape to about 2,500 or more individual but closely aligned superstructure or assemblies or shapes

47. The device in claim 10 uses an adjustable comb or reed assembly to ensure that the 1 superstructure assembly or shape to about 2,500 individual remain closely aligned and spaced from about 0 micrometers to about 10 micrometers.

48. The device in claim 10 presents about 1 superstructure assembly or shape to about 2,500 or more individual but closely aligned superstructure or assemblies or shapes that are each about 600 meters to 20,000 or more meters in length are loaded onto a cylindrical drum.

49. The method in claims 1 through 11 are subjected to a uniform tension from about 35 Newtons to 100 Newtons that ensure that the superstructure assembly or shapes are elongated throughout the process to ensure absorption of wetting agent to effect a permanent change in the surface of the superstructure assembly or shape.

50. The method in claims 1 through 11 are subjected to a uniform tension from about 35 Newtons to 100 Newtons that ensure that the superstructure assembly or shapes are elongated throughout the process to permit penetration and a permanent change in the surface of the superstructure assembly or shape.
